(19) United States
(12) Patent Application Publication
(10) Pub. No.: US 2017/0103655 A1
(43) Pub. Date: Apr. 13, 2017

(54) A MOVEMENT ASSISTANCE APPARATUS, A MOVEMENT ASSISTANCE METHOD AND A PROGRAM FOR MOVEMENT ASSISTANCE

(71) Applicant: PIONEER CORPORATION, Tokyo (JP)

(72) Inventor: Masao ISHIKAWA, Saitama (JP)

(73) Assignee: PIONEER CORPORATION, Tokyo (JP)

(21) Appl. No.: 15/128,435

(22) PCT Filed: Mar. 31, 2014
(86) PCT No.: PCT/JP2014/059532

§ 371 Date: Sep. 23, 2016

(51) Int. Cl. G08G 1/16

(52) U.S. Cl. CPC G08G 1/163; G08G 1/166

(57) ABSTRACT

Provided is a movement assistance device that is capable of performing effective travel assistance even in a vehicle in which there is no map data or the like. When assisting the movement of a vehicle C, vehicle information that corresponds to a vehicle other than the vehicle C is acquired and it is determined on the basis of the acquired vehicle information whether the vehicle C and the other vehicle are moving along the same road. When the other vehicle and the vehicle C are moving along the same road, road data that is related to the road is acquired from the other vehicle and it is determined whether the vehicle C requires travel assistance in which the road data is used. When it is determined that travel assistance is required, travel assistance in which the road data is used is executed.

### TECHNICAL FIELD

The present invention falls under a technical field of a movement assistance apparatus, a movement assistance method and a program for movement assistance and more specifically a technical field of a movement assistance apparatus and a movement assistance method, which assist a movement of a movable body, and a program for the above-mentioned movement assistance apparatus.

### BACKGROUND OF THE INVENTION

There have recently been considered a mutual use of map data between two or more vehicles, which are apart from each other by a communication distance, in communications, in order to improve, for example, the accuracy of issuing warnings for safe driving, and others. In the following description, “communication between two or more vehicles, which are apart from each other by a communication distance” will hereinafter merely be referred to as a “vehicle-to-vehicle communication”. As a document disclosing a prior art of such a vehicle-to-vehicle communication, for example, Patent Document 1 indicated below may be presented. In the prior art described in the above-mentioned Patent Document 1, in a case where a road on which one's own vehicle is running crosses, in a planar view, other road on which other vehicle is running at an area around the one's own vehicle, there is made a comparison in attitude (elevation) between these vehicles, utilizing the above-mentioned vehicle-to-vehicle communication, to determine whether or not any one of these vehicles is running on an elevated road. This prior art is configured, in a case where any one of these vehicles is running on the elevated road, not to issue the warning on the basis of a determination that there is no possibility of collision.

### PRIOR ART DOCUMENT

### Patent Document

[Patent Document 1] PCT International Publication No. 2008-146507

### DISCLOSURE OF THE INVENTION

### Problem to be Solved by the Invention

However, in the prior art disclosed in Patent Document 1 as indicated above, the one's own vehicle requires map data provided in it, in order to confirm other vehicles at an area around the one's own vehicle to drive safely, utilizing the vehicle-to-vehicle communication. In Patent Document 1 as indicated above, there is no consideration of a vehicle, which is not provided with map data in it.

An object of the present invention, which was made in view of the above-mentioned problems, is, as an example, to provide a movement assistance apparatus and a movement assistance method, which permit to provide an effective running assistance even in a vehicle, which is not provided with map data in it, as well as a program for the above-mentioned movement assistance apparatus.

### Means to Solve the Problem

In order to solve the above-mentioned problem, the invention claimed in claim 1 is of a movement assistance apparatus, which is to be used in a movable body to provide movement assistance for assistance of movement of said movable body, comprises: a present positional information acquisition means, as an interface, etc., that acquires a present positional information indicative of a present position of said movement assistance apparatus; a movable body information acquisition means, as the interface, etc., that acquires movable body information of other movable body than said movable body in which said movement assistance apparatus is used; a movement determination means, as a movement determination unit, that determines, based on the present positional information and movable body information as acquired, whether or not said movable body in which said movement assistance apparatus is used and said other movable body are moving on a same movement way; a movement way information acquisition means, as the interface, etc., that acquires, in a case where said other movable body is moving on said same movement way, movement way information related to the movement way in which said other movable body is located, from said other movable body; and an assistance means, as a assistance unit, that provides said movement assistance based on the movement way information as acquired.

In order to solve the above-mentioned subject, the invention claimed in claim 8 is of a movement assistance method, which is to be carried out in a movement assistance apparatus, said movement assistance apparatus being to be used in a movable body to provide movement assistance for assistance of movement of said movable body, comprises the steps of: a present positional information acquisition step of acquiring a present positional information indicative of a present position of said movement assistance apparatus; a movable body information acquisition step of acquiring movable body information of other movable body than said movable body in which said movement assistance apparatus is used; a movement determination step of determining, based on the present positional information and movable body information as acquired, whether or not said movable body in which said movement assistance apparatus is used and said other movable body are moving on a same movement way; a movement way information acquisition step of acquiring, in a case where said other movable body is moving on said same movement way, movement way information related to the movement way in which said other movable body is located, from said other movable body; and an assistance step of providing said movement assistance based on the movement way information as acquired.

In order to solve the above-mentioned subject, the invention claimed in claim 9 is a movement assistance program, which is to be executed by a computer provided in a movement assistance apparatus that is to be used in a movable body to provide movement assistance for assistance of movement of said movable body, to cause the computer to function as: a present positional information acquisition means that acquires a present positional information indicative of a present position of said movement assistance apparatus; a movable body information acquisition means that acquires movable body information of other movable body than said movable body in which said movement assistance apparatus is used; a movement determination means that determines, based on the present positional information and movable body information as acquired, whether or not said movable body in which said movement assistance apparatus is used and said other movable body are moving on a same movement way; a movement way information acquisition means that acquires, in a case where said other movable body is moving on said same movement way, movement way information related to the movement way in which said other movable body is located, from said other movable body; and an assistance means that provides said movement assistance based on the movement way information as acquired.

### BRIEF DESCRIPTION OF THE DRAWINGS

FIG. 1 is a block diagram showing a schematic configuration of a movement assistance apparatus according to an embodiment;

FIG. 2 is a block diagram showing a schematic configuration of a vehicle-to-vehicle communication system according to an example;

FIG. 3 is a block diagram showing a schematic configuration of a terminal apparatus according to the example of the present invention;

FIG. 4 is a flowchart showing a running assistance process according to the example; and

FIG. 5 are schematic diagrams showing, as an example, the running assistance process according to the example, and more specifically, FIG. 5(a) shows the first example and FIG. 5(b) shows the second example.

### EMBODIMENTS FOR CARRYING OUT THE INVENTION

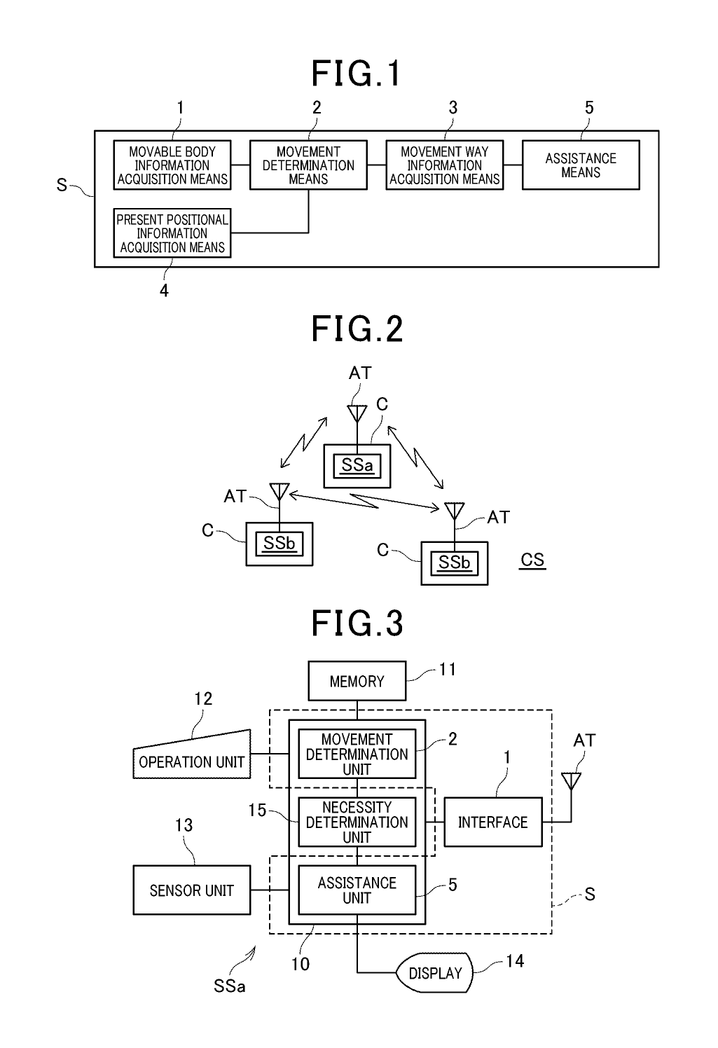

Now, an embodiment by which the present invention can be carried out will be described with reference to FIG. 1. FIG. 1 is a block diagram showing a schematic configuration of a movement assistance apparatus according to the embodiment.

As shown in FIG. 1, a movement assistance apparatus S according to the embodiment of the present invention is used in a movable body and is a movement assistance apparatus, which is to provide movement assistance for assistance of movement of the movable body and is provided with a movable body information acquisition means 1, a movement determination means 2, a movement way information acquisition means 3, a present positional information acquisition means 4 and an assistance means 5. In this case, the “movable body” may include a vehicle as a transportation device, such as an automobile, a motorcycle, a bicycle, etc., and further include a human who moves, being equipped with the movement assistance apparatus S according to the embodiment.

In such a configuration, the present positional information acquisition means 4 acquires present positional information indicative of a present position of the movement assistance apparatus S.

On the other hand, the movable body information acquisition means 1 acquires movable body information of other movable body than the movable body in which the movement assistance apparatus S is used.

Then the movement determination means 2 determines, based on the present positional information and movable body information as acquired by the present positional information acquisition means 4 and the movable body information acquisition means 1, respectively, whether or not said movable body in which the movement assistance apparatus S is used and the other movable body are moving on the same movement way.

Then, the movement way information acquisition means 3 acquires, in a case where the other movable body is moving on the same movement way, movement way information related to the movement way in which the other movable body is located, from the other movable body.

Then the assistance means 5 provides the movement assistance based on the movement way information as acquired by the movement way information acquisition means 3.

As described in the foregoing, in an operation of the movement assistance apparatus S according to the embodiment, the movable body information corresponding to the other movable body is acquired, there is determined whether or not the movable body is moving on the same movement way, and the movement way information related to the other movable body is acquired, in a case where the other movable body is moving on the same movement way. Then the movement assistance is provided based on the above-mentioned movement way information. The movement assistance is conducted based on the movement way information from the other movable body in this manner, with the result that, even if the movement assistance apparatus is used, for example, in a movable body which is not provided with any individual movement way information, effective movement assistance for this movable body can be conducted.

### Example

Now, a specific example corresponding to the embodiment as described above will be described with reference to FIGS. 2 to 5. There will be described below an example in which the embodiment is applied to a vehicle-to-vehicle communication system, which is configured to assist driving of vehicles corresponding to examples of the movable body according to the embodiment, through terminal apparatuses respectively mounted on the above-mentioned vehicles.

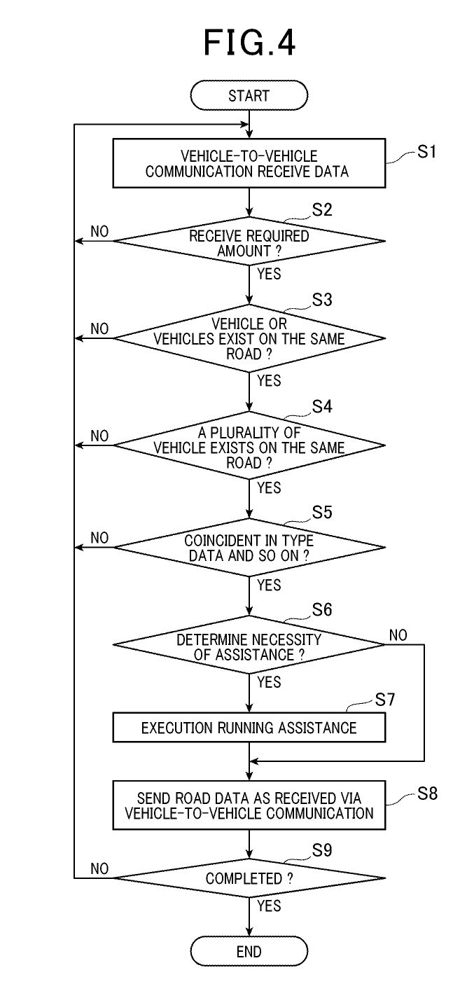

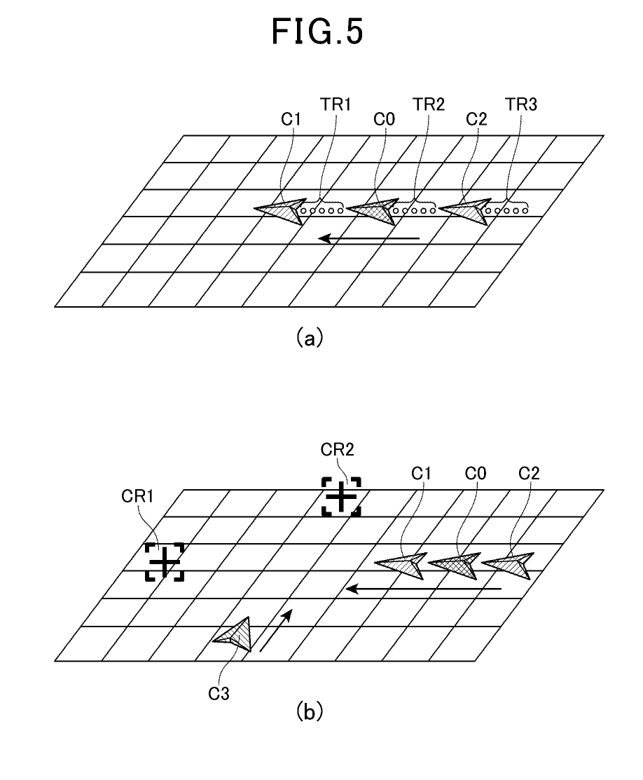

Further, FIG. 2 is a block diagram showing a schematic configuration of the vehicle-to-vehicle communication system according to the example, and FIG. 3 is a block diagram showing a schematic configuration of the terminal apparatus according to the example. In addition, FIG. 4 is a flowchart showing a running assistance process according to the example, and FIG. 5 are schematic diagrams showing, as an example, the running assistance process according to the example. In this case, in FIG. 3, the same reference numerals as the structural components of the movement assistance apparatus S according to the embodiment as shown in FIG. 1 are assigned to the respective structural components of the example corresponding to the respective structural components of the above-described movement assistance apparatus S. FIG. 5 is a view showing schematically the running assistance process according to the example in terms of the data processing.

As shown in FIG. 2, the vehicle-to-vehicle communication system CS according to the example is configured by the terminal apparatuses SS, which are mounted on each of the vehicles C so that various kinds of data can be exchanged by a mutual connection through a direct radio communication via antennas AT. Here, the terminal apparatus SS by which the vehicle-to-vehicle communication system CS is comprised includes a terminal apparatus SSb that stores map data for guidance in itself, and a terminal apparatus SSa according to the example, in which the above-mentioned map data is not recorded in itself.

Now, a configuration and a general outline of an operation of the terminal apparatus SSa according to the example will be described with reference to FIG. 3.

As shown in FIG. 3, the terminal apparatus SSa according to the example is comprised by an interface 1 connected to the antenna AT, a processing unit 10 including a CPU, a ROM (Read Only Memory), a RAM (Random Access Memory), etc., a memory 11 having a volatile area and a non-volatile area, an operation unit 12 having operation buttons or a touch panel, etc., a sensor unit 13 having various kinds of sensors, etc., the sensor unit 13 detecting a present position of a vehicle C provided with the terminal apparatus SSa, and a display 14 having a liquid crystal display, etc., for displaying required information for the terminal apparatus SSa. In this case, the interface 1 corresponds to each of an example of the movable body information acquisition means 1, an example of the present position information requisition means 4 and an example of the movement way information acquisition means 3 according to the embodiment, as well as an example of the “provision means” according to the present application. The display 14 corresponds to an example of the “output unit” according to the present application.

The processing unit 10 is configured by a movement determination unit 2, an necessity determination unit 15 and an assistance unit 5, which corresponds to an example of the assistance means 5 according to the embodiment of the present invention. The movement determination unit 2 corresponds to each of an example of the movement determination means 2 according to the embodiment and an example of the “detection means” according to the present application. The necessity determination unit 15 corresponds to each of an example of the “environment determination unit” and an example of the “necessity determination means” according to the present application. The assistance unit 5 corresponds to an example of the assistance means 5 according to the embodiment. In this case, each of the movement determination unit 2, the necessity determination unit 15 and the assistance means 5 may be implemented by a hardware logic circuit by which the processing unit 10 is configured, or implemented in a software-based manner by causing the processing unit 10 to read out a running assistance process program as described later to implement it. In addition, an example of the movement assistance apparatus S according to the embodiment is configured by the interface 1, the movement determination unit 2 of the processing unit 10, and the assistance means 5 (see a dashed line in FIG. 3).

In the above-described configuration, the interface 1 controls a data exchange with the other terminal apparatus SSb under control of the processing unit 10. On the other hand, the memory 11 stores temporarily the required data, etc. for the processing unit 10 to execute the running assistance process according to the example of the present invention, and such data may be read out where appropriate. In addition, the sensor unit 13 detects, autonomously or in a manner in which navigation radio waves are received from GPS (Global Positioning System) navigation satellites, or other manner, the present position of the terminal apparatus SSa and outputs the present positional data indicative of the above-mentioned present position to the processing unit 10. In addition, carrying out the operation, etc. for specifying the operation as the terminal apparatus SSa, causes the operation part 12 to output operation signals corresponding to the above-mentioned operation, etc. to the processing unit 10. With these, the processing unit 10 executes the running assistance process according to the example, while causing the required information to be displayed in the display 14. In this case, the movement determination unit 2, the necessity determination unit 15 and the assistance unit 5 of the processing unit 10 play a central role in execution of the above-mentioned running assistance process.

Next, the running assistance process according to the example will be described more specifically with reference to FIG. 3 to FIG. 5. For example, the starting operation for example in the operation part 12 causes, as a trigger, the running assistance process according to the example to start. In the following description, when describing the common issues to the vehicle C0 to vehicle C3, such a vehicle will simply be referred to as the “vehicle C”.

More specifically, in the running support process according to the example, the processing unit 10 acquires first, when the above-mentioned starting operation is carried out, the required data for this running assistance process through a direct radio wave communication (the vehicle-to-vehicle communication) from the terminal apparatus SSb of the other vehicle C via the interface 1 and the antenna AT (Step S1). The data acquired from the other terminal apparatus SSb by the processing of this step S1 may include for example source identification data, address identification data, present positional data, type data, shape data, intersection data, trace data, distance data, etc. Of these, the source identification data, the address identification data, the present positional data, the trace data and the distance data correspond for example to an example of the movable body information according to the embodiment, and the type data, the shape data and the intersection data correspond for example to an example of the movement way information according to the embodiment. In this case, the source identification data are data with which the vehicle C in which the above-mentioned terminal apparatus SSb is mounted can be distinguishable from the other vehicle C. Further, the address identification data are data with which the vehicle C in which the terminal apparatus SSa as a destination (address) is mounted can be distinguishable from the other vehicle C. Further, the present positional data are data indicative of the present position of the vehicle C in which the terminal apparatus SSb is mounted. Further, the type data are data indicative of a type of road on which this vehicle C is presently running (for example, the type of an ordinary road or an express way on which it is running). Further, the shape data are data indicative of, for example by so-called linkage data or node data, a shape of the road on which this vehicle C is presently running. The intersection data are data indicative of a position of the nearest intersection to the vehicle C, in the running direction of it on the road on which it is presently running, a distance and azimuth direction to this intersection, a shape of this intersection, an existence of road signals at this intersection, etc. The trace data are data indicative of a running history (a running trace) of this vehicle C. Finally, the distance data are data indicative of a distance between the vehicle C on which the terminal apparatus SSb is mounted and the other vehicle C on which the terminal apparatus SSa is mounted (an inter-vehicular distance between them in a case where they are running on the same road in the same direction). In this case, the type data, the shape data and the intersection data are sent due to the fact that map data for a normal guidance are recorded in the vehicle C on which the terminal apparatus SSb is mounted.

After the start of receiving the various kinds of data in Step S1, the processing unit 10 determines whether or not data in predetermined amounts required for making determinations in Step S3 and Step S4 described later have been acquired (Step S2). In a case where the data in the required amounts have not as yet been acquired in the determination of Step S2 (Step S2; NO), the processing unit 10 causes the processing to return to the above-mentioned Step S1 to continue to acquire the various kinds of data. On the other hand, in a case where the data in the required amounts have been acquired in the determination of Step S2 (Step S2; YES), next, the movement determination unit 2 of the processing unit 10 then determines, based on the data as acquired by Step S1 and the present positional data as outputted from the sensor unit 13 of the terminal apparatus SSa itself, whether or not there exists any other vehicle C (the vehicle C on which the other terminal apparatus SSb is mounted), which is presently running on the same road on which the vehicle in which the terminal apparatus SSa is mounted is presently running (Step S3).

Here, in a case where the above-mentioned trace data indicative of the trace TR1 of the vehicle C1, the above-mentioned shape data and the above-mentioned present positional data have been sent to the vehicle C0 (its running trace is indicated as the trace TR0) in which the terminal apparatus SSa according to the example is mounted, from the terminal apparatus SSb mounted on the vehicle C1, which is running forward on the same road, as shown for example in FIG. 5(a), the movement determination unit 2 determines a degree of coincidence between the running trace, which is presented by this trace data and the shape data and the running trace of the vehicle C0, and determines, in a case where the above-mentioned degree of coincidence is equal to or larger than a predetermined threshold, that the vehicle C1 is running on the same road as that of the vehicle C0 (one's own vehicle). Further, in a case where the above-mentioned trace data indicative of the trace TR2 of the vehicle C2, the above-mentioned shape data and the above-mentioned present positional data have been sent to the vehicle C0 from the terminal apparatus SSb mounted on the vehicle C2, which is running rearward on the same road, the movement determination unit 2 also determines a degree of coincidence between the running trace, which is presented by this trace data and the shape data and the running trace of the vehicle C0, and determines, in a case where the above-mentioned degree of coincidence is equal to or larger than a predetermined threshold, that the vehicle C2 is running on the same road as that of the vehicle C0.

Further, the movement determination unit 2, which makes a determination in Step S3, may further determine, for example in a case where the above-mentioned distance data from the vehicle C1 (or the vehicle C2) have been received, the variation in the inter-vehicular distance between the vehicle C1 and the vehicle C0 (or the variation in the inter-vehicular distance between the vehicle C2 and the vehicle C0) is equal to or less than the predetermined threshold, that the two vehicles C (the vehicle C0 and the vehicle C1, or the vehicle C0 and the vehicle C2) are running on the same road.

In a case where it is determined that no other vehicle C is running on the same road, in Step S3 (Step S3; NO), the processing unit 10 causes the processing to return to the above-mentioned Step S1 to continue to acquire the various kinds of data. In a case where it is determined the other vehicle C is running on the same road, in Step S3 (Step S3; YES), on the other hand, the movement determination unit 2 then determines whether or not there exists one or a plurality of vehicles, which is running on the same road as the road on which the vehicle C0 in which the terminal apparatus SSa is mounted is presently running (Step S4). In the determination in Step S4, the movement deter urination unit 2 determines, based on the determination results as to whether or not there exists one or a plurality of vehicles, which has been determined to be running on the same road in the above-mentioned Step S3, whether or not the plurality of vehicles C is running. In a case of an example as shown for example in FIG. 5(a), it is determined that there exist two vehicles of the vehicle C1 and the vehicle C2, which are running on the same road ahead and behind of the vehicle C0, respectively (Step S4; YES). In a case where the other vehicle C, which is running on the same road, is determined only as a single vehicle in the determination of Step S4 (Step S4; NO), the processing unit 10 causes the processing to return to the above-mentioned Step S1 to continue to acquire the various RI kinds of data. In a case where the other vehicle C, which is running on the same road, is determined as a plurality of vehicles in the determination of Step S4 (Step S4; YES), on the other hand, the processing unit 10 then determines whether or not for example the contents of the above-mentioned type data, of the data as received from the above-mentioned plurality of vehicles C, are coincident with each other (Step S5). In a case where the both data are not coincident with each other in the determination of Step S5 (Step S5; NO), resulting in a difference in the type of the road, even in the determination result that they are running on the same road, the data as received from each of the vehicles C may have a low degree of confidence. In this case, the processing unit 10 accordingly causes the processing to return to the above-mentioned Step S1 to continue to acquire the various kinds of data. Further, factors, which cause the determination of Step S5 as “NO” (the factors for lowering the degree of confidence), may for example include difference in version between the map data as recorded in the vehicle C1 and the vehicle C2, respectively.

To the contrary, in a case where the respective data are coincident with each other in the determination of Step S5 (Step S5; YES), there is determined that the data as received have a high degree of confidence, and the processing unit 10 then determines, utilizing the above-mentioned type data, etc. as received from the vehicle C1 and the vehicle C2, which are determined to be running on the same road, whether or not for example a driver of the vehicle C0 in which the terminal apparatus SSa is mounted, requires for a running assistance (Step S6). In a case where no assistance is determined to be required (Step S6; NO), the processing moves to Step S8 described later, and in a case where assistance is determined to be required (Step S6; YES), the assistance means 5 of the processing unit 10 causes the running assistance to be conducted in accordance with the determination result (Step S7).

Now, the running assistance process according to Step S6 and Step S7 as mentioned above will be described as an example with reference to FIG. 5(b).

There is an assumption that a vehicle-to-vehicle communication is made between the vehicle C0 in which the terminal apparatus SSa is mounted, and the vehicle C1, vehicle C2 and vehicle C3 in each of which the terminal apparatus SSb is mounted, as shown in FIG. 5(b) (see Step S1 to Step S5 in FIG. 4). There is an assumption that the vehicle C0, the vehicle C1 and the vehicle C2 are running leftward in FIG. 5(b) on an ordinary road in an order as shown as an example in FIG. 5(b). There is a further assumption that, on the other hand, the vehicle C3 is running upward in FIG. 5(b) on an express way, which crosses, in a planar view in an elevated structure, the ordinary road on which the vehicle C0, etc. is running. In this case, the vehicle C1 and the vehicle C2 are determined to be running on the same road of the vehicle C0 (see Step S3; YES and Step S4; YES in FIG. 4), although the vehicle C3 is not determined to be running on the same road (see Step S3; NO). There is a further additional assumption that the processing unit 10 has recognized through the intersection data as described above from the vehicle C1 or the vehicle C2 that an intersection CR1 is located just ahead of the vehicle C0, etc., which are running on the ordinary road, at the nearest position to the vehicle C0, and has recognized that through the intersection data as described above from the vehicle C3 that a fork CR2 which permits entrance into for example a parking area is located just ahead of the vehicle C3 on the express way on which the vehicle C3 is running.

In a case of the example as shown in FIG. 5(b), the necessity determination unit 15 of the processing unit 10 can determine that there is no possibility of collision, not only at the intersection CR1, but also at the intersection CR2, between the vehicle C0, which is running on the ordinary road, and the vehicle C3, which is running on the express way, which crosses, in a planar view in an elevated structure, the above-mentioned ordinary road. In this case, the necessity determination unit 15 therefore determines no running assistance to be required (see Step S6; NO in FIG. 4).

To the contrary, in a case where the above-mentioned type data from the vehicle C3 indicate that for example the vehicle C3 is running on the ordinary road, and it is determined that the position of the intersection CR1, which is located just ahead of the vehicle C0, etc., which are running on the ordinary road, at the nearest position to the vehicle C0 is coincident with the position of the intersection, which is located just ahead of the vehicle C3, which is running on the ordinary road, at the nearest position to the vehicle C3, the necessity determination unit 15 therefore deter mines a running assistance to be required (see Step S6; YES in FIG. 4). Consequently, the assistance unit 5 causes the running assistance to be conducted, by using for example the display 14 or a not-shown audio output part to issue warnings about a possibility that the vehicle C3 may run through the forward intersection CR1, and the like (see Step S7 in FIG. 4). In a case where these vehicles, both of which may enter the intersection CR1, will enter this intersection at different times, or a switching control of electrical signals at the above-mentioned intersection CR1 will prevent these vehicles from entering simultaneously the intersection CR1, or the like, the above-mentioned running assistance about the vehicle C3 may not be provided.

In a case where no running assistance has been determined to be required in Step S6 (Step S6; NO), or the running assistance in Step S7 has been conducted, the processing unit 10 sends the respective data as received from the other vehicle C in the vehicle C0 (including the type data, the shape data, etc. of the road on which the vehicle C0 is running) to the other vehicle C (for example the vehicle C3 shown as an example in FIG. 5(b)) (Step S8).

Then, the processing unit 10 determines whether or not the running assistance process according to the example is caused to quit (Step S9), due to the fact that, for example, the terminal apparatus SSa has been powered off, there has been given an instruction not to conduct the running assistance according to the example, or the like (Step S9). In a case where the running assistance process is to be conducted continuously in the determination of Step S9 (Step S9; NO), the processing unit 10 causes the processing to return to the above-mentioned Step S1. To the contrary, in a case where the running assistance process according to the example is to be caused to quit in the determination of Step S9 (Step S9; YES), the processing unit 10 causes this running assistance process to quit.

As described in the foregoing, according to the operation of the vehicle-to-vehicle communication system CS according to the example, the present positional data, etc. are acquired from the other vehicle C, there is determined whether or not the other vehicle C is moving on the same road (see Step S3 and Step S4 in FIG. 4), and the type data, etc. related to the other vehicle C, which is moving on the same road, are acquired from the other vehicle C (see Step S1 in FIG. 4). Based on these data, there is made a determination of an necessity of the running assistance (see Step S6 in FIG. 4), and in a case where the running assistance is determined to be required, this assistance is provided (see Step S6 in FIG. 4). Thus, the running assistance is provided in a case where the running assistance based on the type data, etc. from the other vehicle C is determined to be required, and it is possible to provide an effective running assistance for the vehicle C0 even, for example, in the terminal apparatus SSa of the vehicle C0, in which individual map data, etc. are not recorded.

In a case where the running assistance has been determined to be required, an existence of the intersection CR1 in the running direction is determined based on the type data, the intersection data, etc., and conditions of this intersection CR1, etc. are output, thus it makes possible to provide an accurate running assistance.

Further, in a case where the data sent from the other vehicle C include at least one of trace data and distance data, a more specific running assistance can be provided based on these data. More specifically, in a case where the trace data are for example sent, a configuration in which there is detected, based on these trace data, a degree of coincidence to the running trace of the other vehicle C, and it is determined based on the degree of coincidence whether or not the vehicle C0 and the vehicle C1 are running on the same road, makes it possible to accurately determine whether or not the respective vehicles C are running on the same road, to provide a running assistance. In addition, in a case where the distance data have been sent, a determination, based on variation in an inter-vehicular distance indicated by the above-mentioned distance data, as whether or not the respective vehicles C are running on the same road, also makes it possible to determine accurately whether or not the respective vehicles C are running on the same road, to provide a running assistance.

Further, in addition, an necessity of a running assistance related to a collision between the respective vehicles C is determined based on the type data as sent from the other vehicle C, thus it makes possible to determine accurately an necessity of a running assistance based on the type of the road.

Further, the data received in the terminal apparatus SSa are sent to the other vehicle C (for example the vehicle C3 shown as an example in FIG. 5(b)), which is moving on the other road than the same road (see Step S8 in FIG. 4), thus making it possible to provide the other vehicle C with the same running assistance as the vehicle C0.

Further, in the example as described above, there is given a description that, in a case of “NO” in each of the determinations of Step S3 to Step S5, the process is caused to go to Step 1, respectively. Alternatively, the process may be configured so that the process is caused to return to Step S6 as described above even in a case of “NO” in each of the determinations of Step S3 to Step S5. In this case there may be a configuration in which, in a case where there could be made, prior to Step S8 as described above, a determination of the type data, etc. for the road on which the vehicle C0 is running, these data are to be sent to the other vehicle C, and in a case where there could not be made a determination of the type data, etc., this sending step is not carried out.

Further, there has been given the example as described above in which the present invention is applied to a vehicle-to-vehicle communication system utilizing a vehicle-to-vehicle communication. In addition, it is possible to apply the present invention to a communication system in which data can be exchanged between vehicles C via a network such as an Internet, for example (namely, via a predetermined server device). In this case, the respective terminal apparatuses SS exchange the data, while making identification each other with the source identification data as described above.

Further, there has been given the example as described above in which the present invention is applied to a vehicle-to-vehicle communication system utilizing a vehicle-to-vehicle communication. In addition, it is also possible to apply the present invention to a system, which provide an movement assistance of a human, as an example of the movable body according to the embodiment, who carries a portable information terminal apparatus (including so called Smartphone), while making a communication between such a portable information terminal apparatus and the other device. In this case, required data are exchanged between the portable information terminal apparatuses, while making identification each other with identification data for making a mutual identification, etc.

Further, in addition, there may be a configuration in which a running assistance program corresponding to the flowchart as shown in FIG. 4 has been recorded in a recording medium such as an optical disc or a hard disc, or has been acquired via a network such as an Internet, etc., and this program is read out by a general purpose microcomputer, etc., to execute it, so as to cause such a microcomputer, etc. to function as the processing unit 10 according to the example.

### DESCRIPTION OF REFERENCE NUMERALS

1 movable body information acquisition means (interface)
2 movement determination means (movement determination unit)
3 movement way information acquisition means
4 present positional information acquisition means
5 assistance means (assistance unit)
10 processing unit
15 necessity determination unit
SSa, SSb terminal apparatus
CS vehicle-to-vehicle communication system
C, C0, C1, C2, C3 vehicle
CR1 intersection
CR2 fork

1. A movement assistance apparatus to provide movement assistance of a movable body, comprising:
a present positional information acquisition means that acquires a present positional information of said movement assistance apparatus;
a movement way information acquisition means that acquires movement way information from other movable body than said movable body, the movement way information being related to the movement way in which said movable body is located;
a determination means that determines a degree of confidence of said movement way information as acquired; and
an assistance means that provides, in a case where said degree of confidence of said movement way information as acquired being high was determined by said determination means, said movement assistance based on the movement way information.

2. The movement assistance apparatus according to claim 1, wherein:
said assistance means comprises:
an environment determination means that determines, based on the movement way information as acquired, at least one of condition of said movement way in which said movable body, in which said movement assistance apparatus is used, is moving and condition of said other movable body related to said movement way as movement environment related to a movement of said movable body; and
an output means that outputs environment information indicative of the movement environment as determined.

3. The movement assistance apparatus according to claim 1, wherein:
said movement assistance apparatus further comprises
a movable body information acquisition means that acquires movable body information of said other movable body, said movable body information including at least one of movement trace information indicative of a trace of the movement of said other movable body and vehicle-to-vehicle distance information related to said other movable body.

4. The movement assistance apparatus according to claim 3, wherein:
said movement assistance apparatus further comprises
a movement determination means that determines, based on the present positional information indicative of a present position of said movement assistance apparatus and said movable body information, whether or not said movable body in which said movement assistance apparatus is used and said other movable body are moving on a same movement way, and wherein,
in a case where said movable body information includes said movement trace information, said movement determination means
detects, based on said movement trace information, a degree of coincidence between the movement trace of said movable body in which said movement assistance apparatus is used and the movement trace of said other movable body, and
determines, based on said degree of coincidence as detected, whether or not said other movable body is moving on said same movement way.

5. The movement assistance apparatus according to claim 3, wherein:
said movement assistance apparatus further comprises
a movement determination means that determines, based on the present positional information indicative of a present position of said movement assistance apparatus and said movable body information, whether or not said movable body in which said movement assistance apparatus is used and said other movable body are moving on a same movement way, and wherein,
in a case where said movable body information includes said vehicle-to-vehicle distance information, said movement determination means detects, based on said vehicle-to-vehicle distance information, variation in distance between said movable body in which said movement assistance apparatus is used and said other movable body, and
determines, based on the variation as detected, whether or not said other movable body is moving on said same movement way.

6. The movement assistance apparatus according to claim 1, wherein:
said movement way information acquisition means further acquires a type information indicative of a type of other movement way than said movement way in which said movable body is located,
said movement assistance apparatus further comprises:
an necessity determination means that determines, based on the type information as acquired, an necessity of said movement assistance related to a collision between said other movable body, said other movable body being moving on said other movement way, said type of said other movement way being indicated through the type information as acquired, and said movable body in which said movement assistance apparatus is used,
said assistance means provides said movement assistance based on the movement way information as acquired, in a case where said movement assistance related to said collision is determined to be required.

7. The movement assistance apparatus according to claim 1 further comprising:
a provision means that provides the other movable body, the other movable body being moving on the other movement way than said movement way in which said movable body is located, with input information corresponding to the movement way information as acquired.

8. A movement assistance method, which is to be carried out in a movement assistance apparatus to provide movement assistance of a movable body, comprising the steps of:
a present positional information acquisition step of acquiring a present positional information of said movement assistance apparatus;
a movement way information acquisition step of acquiring movement way information from other movable body than said movable body, the movement way information being related to the movement way in which said movable body is located;
a determination step of determining a degree of confidence of said movement way information as acquired; and
an assistance step of providing, in a case where said degree of confidence of said movement way information as acquired being high was determined in said determination step, said movement assistance based on the movement way information.

9. (canceled)

10. A movement assistance apparatus to provide movement assistance of a movable body, comprising:
at least one memory operable to store program code; and
as least one processor operable to read the program code and operate as instructed by the program code, the program code including:
a present-positional-information-acquisition code configured to cause the at least one processor to acquire a present positional information of said movement assistance apparatus;
a movement-way-information-acquisition code configured to cause the at least one processor to acquire movement way information from a plurality of other movable bodies than said movable body, each said movement way information being related to the movement way in which said movable body is located;
a determination code configured to cause the at least one processor to determine a degree of confidence of said movement way information as acquired by determining whether or not contents of the movement way information acquired from the plurality of other movable bodies are coincident with each other; and
an assistance code configured to cause the at least one processor to provide, in a case where said degree of confidence of said movement way information as acquired being high was determined by said determination code, said movement assistance based on the movement way information.

11. A movement assistance method to be carried out in a movement assistance apparatus to provide movement assistance of a movable body, the movement assistance apparatus including at least one processor, the movement assistance method comprising:
said at least one processor acquiring a present positional information of said movement assistance apparatus;
said at least one processor acquiring movement way information from a plurality of movable bodies other than said movable body, each said movement way information being related to the movement way in which said movable body is located;
said at least one processor determining a degree of confidence of said movement way information as acquired by determining whether or not contents of the movement way information acquired from the plurality of other movable bodies are coincident with each other; and
said at least one processor providing, in a case where said degree of confidence of said movement way information as acquired was determined to be high, said movement assistance based on the movement way information.

12. A movement assistance apparatus to provide movement assistance of a movable body, comprising:
a present-positional-information-acquisition device configured to acquire a present positional information of said movement assistance apparatus;
a movement-way-information-acquisition device configured to acquire movement way information from a plurality of movable bodies other than said movable body, each said movement way information being related to the movement way in which said movable body is located;
a determination device configured to determine a degree of confidence of said movement way information as acquired by determining whether or not contents of the movement way information acquired from the plurality of other movable bodies are coincident with each other; and
an assistance device configured to provide, in a case where said determination device determined that said degree of confidence of said movement way information as acquired was high, said movement assistance based on the movement way information.

13. The movement assistance apparatus according to claim 2, wherein:
said movement assistance apparatus further comprises
a movable body information acquisition means that acquires movable body information of said other movable body, said movable body information including at least one of movement trace information indicative of a trace of the movement of said other movable body and vehicle-to-vehicle distance information related to said other movable body.

14. The movement assistance apparatus according to claim 2, wherein:
said movement way information acquisition means further acquires a type information indicative of a type of other movement way than said movement way in which said movable body is located,
said movement assistance apparatus further comprises:
an necessity determination means that determines, based on the type information as acquired, an necessity of said movement assistance related to a collision between said other movable body, said other movable body being moving on said other movement way, said type of said other movement way being indicated through the type information as acquired, and said movable body in which said movement assistance apparatus is used,
said assistance means provides said movement assistance based on the movement way information as acquired, in a case where said movement assistance related to said collision is determined to be required.

15. The movement assistance apparatus according to claim 3, wherein:
said movement way information acquisition means further acquires a type information indicative of a type of other movement way than said movement way in which said movable body is located,
said movement assistance apparatus further comprises:
an necessity determination means that determines, based on the type information as acquired, an necessity of said movement assistance related to a collision between said other movable body, said other movable body being moving on said other movement way, said type of said other movement way being indicated through the type information as acquired, and said movable body in which said movement assistance apparatus is used,
said assistance means provides said movement assistance based on the movement way information as acquired, in a case where said movement assistance related to said collision is determined to be required.

16. The movement assistance apparatus according to claim 4, wherein:
said movement way information acquisition means further acquires a type information indicative of a type of other movement way than said movement way in which said movable body is located,
said movement assistance apparatus further comprises:
an necessity determination means that determines, based on the type information as acquired, an necessity of said movement assistance related to a collision between said other movable body, said other movable body being moving on said other movement way, said type of said other movement way being indicated through the type information as acquired, and said movable body in which said movement assistance apparatus is used,
said assistance means provides said movement assistance based on the movement way information as acquired, in a case where said movement assistance related to said collision is determined to be required.

17. The movement assistance apparatus according to claim 5, wherein:
said movement way information acquisition means further acquires a type information indicative of a type of other movement way than said movement way in which said movable body is located,
said movement assistance apparatus further comprises:
an necessity determination means that determines, based on the type information as acquired, an necessity of said movement assistance related to a collision between said other movable body, said other movable body being moving on said other movement way, said type of said other movement way being indicated through the type information as acquired, and said movable body in which said movement assistance apparatus is used,
said assistance means provides said movement assistance based on the movement way information as acquired, in a case where said movement assistance related to said collision is determined to be required.

18. The movement assistance apparatus according to claim 2 further comprising:
a provision means that provides the other movable body, the other movable body being moving on the other movement way than said movement way in which said movable body is located, with input information corresponding to the movement way information as acquired.

19. The movement assistance apparatus according to claim 3 further comprising:
a provision means that provides the other movable body, the other movable body being moving on the other movement way than said movement way in which said movable body is located, with input information corresponding to the movement way information as acquired.

20. The movement assistance apparatus according to claim 4 further comprising:
a provision means that provides the other movable body, the other movable body being moving on the other movement way than said movement way in which said movable body is located, with input information corresponding to the movement way information as acquired.
